(19) United States
(12) Patent Application Publication
(10) Pub. No.: US 2021/0024040 A1
(43) Pub. Date: Jan. 28, 2021

(54) METHOD FOR AUTOMATICALLY DETECTING A LOADING SURFACE AND WASHING INSTALLATION FOR CARRYING OUT SAID METHOD

(71) Applicant: Washtec Holding GmbH, Augsburg (DE)

(72) Inventor: Franz Steininger, Dinkelscherben (DE)

(21) Appl. No.: 17/066,392

(22) Filed: Oct. 8, 2020

Related U.S. Application Data
(63) Continuation of application No. PCT/EP2019/058768, filed on Apr. 8, 2019.

(30) Foreign Application Priority Data
Apr. 9, 2018 (DE) 10 2018 108 343.2

(51) Int. Cl. B60S 1/66; G01B 11/24; G01B 17/06; G01B 15/04; G01B 11/06; G01B 17/02; G01B 15/02; G06T 7/60

(52) U.S. Cl. CPC B60S 1/66; G01B 11/24; G01B 17/06; G01B 15/04; G06T 2207/30252; G01B 17/02; G01B 15/02; G06T 7/60; G01B 11/0608

(57) ABSTRACT

An automatic detection method for automatically detection a loading surface of a vehicle, includes determining a side contour of a vehicle, determining a height profile of the vehicle, calculating a deviation between the side contour and the height profile, and determining the loading surface based on the deviation.

### CROSS REFERENCE TO RELATED APPLICATIONS

This application is a continuation application of international patent application PCT/EP2019/058768, filed Apr. 8, 2019, designating the United States and claiming priority to German application DE 10 2018 108 343.2, filed Apr. 9, 2018, and the entire content of both applications is incorporated herein by reference.

### TECHNICAL FIELD

The present disclosure relates to a method for the automatic detection of a loading area of a vehicle and a vehicle washing system.

### BACKGROUND

Vehicles with loading areas, such as pick-ups, trucks with flatbeds platforms or tippers, require special treatment processes for automated vehicle cleaning in a vehicle washing system. Torque-controlled horizontal treatment brushes of the vehicle washing system would sit on the side walls of these vehicles and cause damage due to the small contact surfaces.

Known are systems that control the washing process by manually preselecting special programs for this type of vehicle in such a way that no damage occurs. Furthermore, there are systems that monitor the lowering movement of the roof brush and assume that the vehicle is a vehicle with side walls (tailgates) when the brush is lowered in a predefined area with a predefined depth.

### SUMMARY

It is therefore an object of the present disclosure to prevent damage to a vehicle during washing in a vehicle washing system and to automatically determine a washing program.

This object is achieved by a method for automatically detecting a lower-lying loading area of a vehicle and a vehicle washing system as described herein.

According to a first aspect, the task is solved by a method for automatically detecting a loading area of a vehicle, comprising the steps of determining a side contour of a vehicle; determining a height profile of the vehicle; calculating a deviation between the side contour and the height profile; and determining the loading area based on the deviation. The side contour indicates the height profile of the vehicle above the ground in side view. The height profile indicates the height of the vehicle above the ground in top view, such as in the center of the vehicle.

This procedure can simplify the operation of a vehicle washing system and prevent damage during the car wash. The programme sequences of the car wash can be automatically adjusted to the vehicle. By automatically detecting and measuring loading areas, the program can optimally adjust the washing process. The deviation can also be used to determine the depth of the loading area in relation to a side wall.

In a technically advantageous version of the method, the position and/or extent of the loading area is determined from a course of the deviation. The loading area is located between the points where the deviation between the height profile and the side contour increases and decreases. This allows conclusions to be drawn about the position and length of the loading area. This provides the technical advantage, for example, that lowering of the brush in this area can be precisely prevented.

In another technically advantageous embodiment of the method, the side contour is determined by an electronic camera that records a side view of the vehicle. The side contour of the vehicle can be determined by image recognition. This has the technical advantage, for example, that the side contour can be determined quickly.

In another technically advantageous embodiment of the method, the side contour is determined by a light grid moving along the vehicle. This has the technical advantage, for example, that the side contour can be determined precisely.

In another technically advantageous embodiment of the method, the side contour is determined by an ultrasonic or radar sensor. This has the technical advantage, for example, that the side contour can also be determined in poor light conditions or spray mist.

In another technically advantageous embodiment of the method, the height profile is determined in the middle of the vehicle. This provides the technical advantage, for example, that the height profile reliably covers the area of the loading area.

In another technically advantageous embodiment of the method, the height profile is determined by measuring the runtime of light. This has the technical advantage, for example, that the height profile can be determined with little effort.

In another technically advantageous embodiment of the method, the height profile is determined by triangulation of light. This also has the technical advantage, for example, that the height profile can be determined with little effort.

In another technically advantageous embodiment of the method, the height profile is determined by an ultrasonic or radar sensor. This has the technical advantage, for example, that the height profile can be determined even in poor lighting conditions or spray mist.

In another technically advantageous embodiment of the method, a first height profile is determined by a radar sensor and a second height profile by a light sensor. If there is a tarpaulin (cover sheet) over the loading area, the radar beam of the radar sensor is reflected by the metal parts of the loading area. The light beam from the light sensor is reflected by the tarpaulin instead. If the first height profile differs from the second height profile, the presence of a tarpaulin on the loading area can be assumed. This has the technical advantage, for example, that the tarpaulin can be cleaned with less pressure from the brush and damage is prevented.

Another technically advantageous version of the process is used in a vehicle washing system. The technical advantage is, for example, that the vehicle washing system can take into account the presence of a loading area during cleaning.

According to a second aspect, the task is solved by a vehicle washing system, comprising a first measuring system for determining a side contour of a vehicle; a second measuring system for determining a height profile of the vehicle; and an electronic control unit for calculating a deviation between the side contour and the height profile and determining the loading area based on the deviation. This provides the same technical advantages as the method according to the first aspect.

### BRIEF DESCRIPTION OF THE DRAWINGS

The disclosure will now be described with reference to the drawings wherein:

FIG. 1 is a side view and a top view of a vehicle with a loading area,

FIG. 2 is a schematic view of a vehicle washing system; and

FIG. 3 is a block diagram of the method.

### DESCRIPTION OF EXEMPLARY EMBODIMENTS

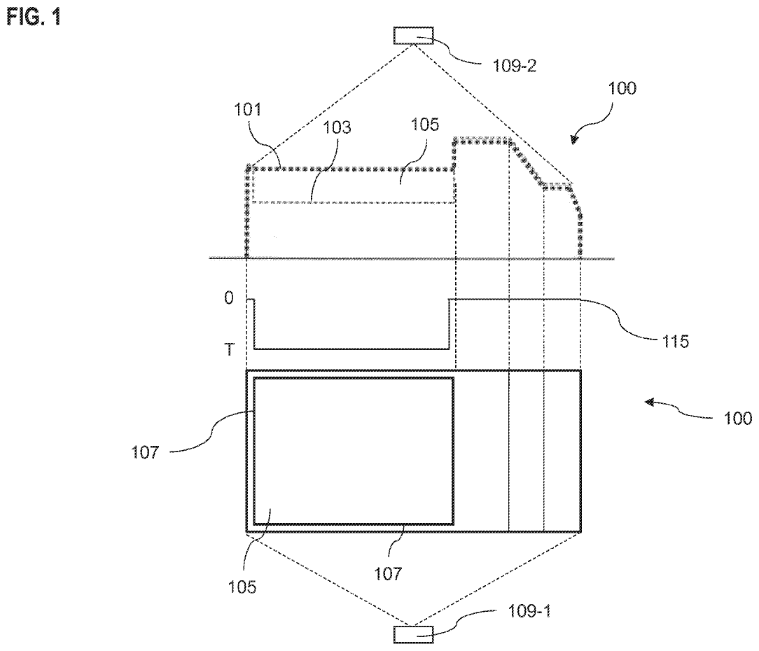

FIG. 1 shows a side view and a top view of a vehicle 100 with a loading area 105. 100 is a pick-up vehicle with a rear loading area 105, which is partially surrounded by vertical side walls 107.

This vehicle type may be identified by a method using two measuring systems to measure the vehicle 100. The first measuring system 109-1 determines the side contour 101 of vehicle 100 in a side view to which the side wall 107 of loading area 105 contributes. The side contour 101 determines the height of the vehicle 100 relative to the ground in side view.

The measuring system 109-1 determines the side contour 101 of the vehicle 100 by scanning the side surfaces. For this purpose, light grids can be used which are arranged on a portal of the vehicle washing system so that they can be moved along. In the same way, imaging methods can be used which determine the side contour 101 of the vehicle 100 with an image recording. Ultrasonic or radar sensors can also be used instead of optical sensors.

A second measuring system 109-2 determines the height profile 103 of the vehicle 100 from above the vehicle. The height profile 103 determines the height profile of the vehicle 100 relative to the ground in the top view, such as in the center of the vehicle. The second measuring system 109-2 determines the height profile 103 of vehicle 100 from above. This measuring system 109-2 can record the height profile 103 of the vehicle 100 with a runtime or triangulation of light, by ultrasound or radar.

If the height profile 103 of the vehicle 100 deviates from the side contour 101, the presence of a loading area 105 with side walls 107 is inferred and a corresponding wash sequence is selected. By using two independent measuring systems 109-1 and 109-2, it is possible to detect the loading area 105 with the side wall 107 and to measure its position and depth T.

By comparing the determined side contour 101 and the height profile 103 of the vehicle 100, the control of the vehicle washing system can clearly calculate the position of an existing loading area 105, since the side contour 101 is detected by the measuring system 109-1, including the side walls 107, and the height profile 103 with the lower-lying loading area 105 is detected by the measuring system 109-2. The deviation 115 can be determined by a difference between the side contour 101 and the height profile 103. If the height profile 103 of the measuring system 109-2 is lower than the side contour 101 of the measuring system 109-1, the vehicle 100 has a loading area 105 in this area and the vehicle washing system program can apply the treatment routines provided.

From the course of deviation 115, the exact position and extent of loading area 105 can also be deduced. The loading area 105 is located between the points where the deviation 115 between the height profile 103 and the side contour 101 rises and falls. In this area, torque control of the brush can be selectively suspended so that damage to the vehicle or the brush is prevented.

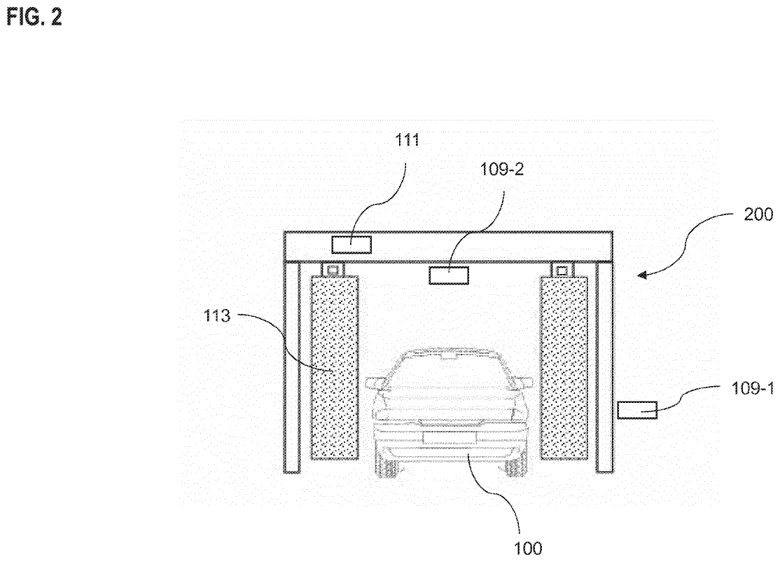

FIG. 2 shows a schematic view of a vehicle washing system 200. The vehicle washing system 200 is used for automatic cleaning of vehicles 200, such as cars or trucks. The cleaning process is carried out mechanically with rotating brushes 113 using water and other liquid chemical washing substances, such as cleaning or care substances. The vehicle washing system 200 is, for example, a gantry car wash (partial washer) or a car wash line for motor vehicles, a commercial vehicle washer or a washer for rail vehicles. For this purpose, the vehicle washing system 200 is controlled electronically by a control unit 111 using control data.

The first measuring system 109-1 is used to determine the side contour 101 of the vehicle 100 and is located at the side of the vehicle 100. The second measuring system 109-2 is used to determine the height profile 103 of vehicle 100 and is arranged above vehicle 100. The two measuring systems 109-1 and 109-2 are used to obtain digital data on the side contour 101 and the height profile 103 of the vehicle. These data can either be obtained in the measuring systems 109-1 and 109-2 or determined by processing raw data in the control unit 111.

Using the digital data, a deviation between the side contour 101 and the height profile 103 can be calculated by the control unit 111. If the deviation exceeds a specified value, for example, it can be detected that vehicle 100 is a vehicle 100 with a loading area 105, surrounded by the side walls 107. If, for example, the deviation is below the specified value, it can be detected that vehicle 100 is a vehicle 100 without loading area 105, such as a limousine. This means that the existence of a loading area 105 can be determined on the basis of the deviation.

The measuring system 109-1 for detecting the side contour 101 comprises, for example, an electronic camera, a light grid, an ultrasonic sensor or a radar sensor that moves along the vehicle. If an electronic camera is used, a lateral image is generated with image data of the vehicle 100. The image data is evaluated using an analysis algorithm to determine a side contour 101 of the vehicle 100. If a light grid is used, the measuring system 109-1 comprises an emitter and receiver bar between which parallel light beams extend. The emitter and receiver bar is moved, for example, together with the portal of the vehicle washing system 200. Depending on which of the light beams are interrupted by the vehicle 100 during movement, a side contour 101 of the vehicle can be determined.

The measuring system 109-1 for detecting the side contour 101 can include an ultrasonic sensor or a radar sensor. With the ultrasonic sensor or a radar sensor, the side contour 101 of the vehicle 100 can be detected non-optically, for example, so that it can be reliably detected even in poor visibility conditions or in spray mist in the vehicle washing system 200. In general, however, any measuring system 109-1 that allows the detection of the side contour 101 of the vehicle 100 can be used.

The measuring system 109-2 for determining the height profile 103 comprises, for example, a system for measuring the runtime of light, a system for triangulating light, an ultrasonic sensor or a radar sensor.

In the time-of-flight measurement, a laser diode emits a laser pulse with a modulated frequency which is reflected by the vehicle. The reflected light beam is bundled by a lens and directed to an optoelectronic receiver unit. Depending on the distance of the vehicle 100, the reflected laser beam strikes the receiver unit with a respective delay.

Using the known speed of light in air, the evaluation unit calculates the distance of the vehicle 100 using the measured runtime of the laser beam. In addition, a phase measurement can be carried out in which the exact delay is determined on the basis of a phase shift between a reference light beam and the reflected light beam.

In the triangulation of light, a laser beam or the radiation of a light-emitting diode is focused on the vehicle 100 and recorded by a camera, a spatially resolving photodiode or a CCD bar arranged in the sensor. If the distance of the vehicle 100 from the sensor changes, the angle at which the light spot is observed also changes, so that the position of the image on the photodetector shifts. From the change in position of the light spot depending on the distance, the angular functions are used to calculate the distance of the vehicle from the measuring system 109-2.

The ultrasound or radar sensor can also determine the distance of the vehicle by calculating the time of flight and allow the height profile 103 to be determined for then, then visually difficult conditions, such as water drops in the air.

In addition, the measuring system 109-2 can include a radar sensor as well as a light sensor. The radar sensor records a first height profile 103, while the light sensor records a second height profile 103 of the vehicle 100. If there is a tarpaulin over the loading area 105, the radar beam of the radar sensor is reflected by the metal parts of the loading area 105. The light beam from the light sensor is reflected by the tarpaulin above it. If the first height profile 103 differs from the second height profile 103, the presence of a tarpaulin on the loading area 105 can be inferred and the washing program adjusted accordingly. In general, however, any measuring system 109-2 can be used that allows the height profile 103 of vehicle 100 to be detected.

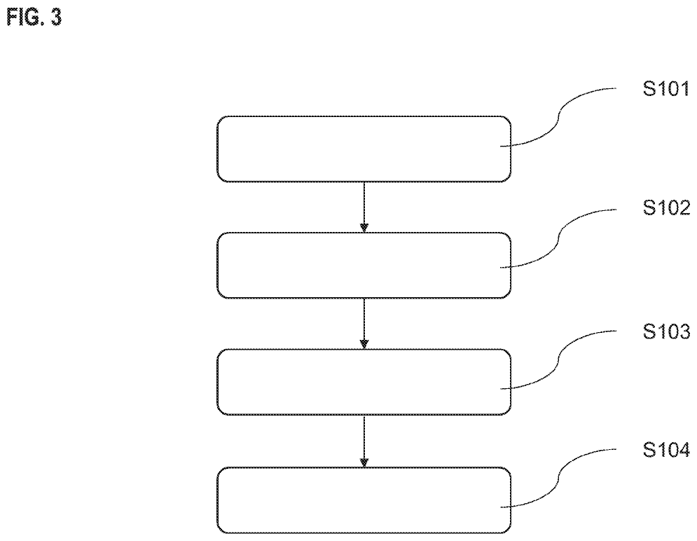

FIG. 3 shows a block diagram of the method. The method is used, for example, for the detection and measurement of vehicle contours in vehicle washing systems. By detecting and measuring vehicles 100 with loading areas 105 the treatment processes for these vehicle types in the vehicle washing system can be optimally adapted.

The method comprises the step S101 of determining the side contour 101 of the vehicle 100 and the step S102 of determining the height profile 103 of the vehicle 100, followed by the step S103 of calculating a deviation between the side contour 101 and the height profile 103. In step S104 the vehicle type or loading area is determined on the basis of the deviation.

This procedure simplifies the operation of the vehicle washing system 200 and prevents damage to the vehicle 100 during washing. The program sequences can be better adapted to the vehicles 100. The automatic detection and measurement of the loading area 105 independent of the vehicle type, as well as the position and size of the loading area 105, allows the program to optimally adjust the washing process.

The vehicle type to be treated no longer needs to be preselected manually. A mishandling or maltreatment of vehicles 100 whose loading areas 105 are not within the predefined ranges of the previous systems is excluded. In addition, it is prevented that a wrong entry in the manual preselection will cause problems during vehicle washing.

Sensory detection of the vehicle type with characteristic differences of differently determined contour data in the side view and in the top view is universally applicable to all current and future vehicles.

All features explained and shown in connection with individual embodiments of the disclosure may be provided in different combinations in the subject-matter of the disclosure in order to realize their beneficial effects at the same time.

All method steps can be implemented with devices which are suitable for carrying out the respective method step. All functions that are carried out by physical features can be a method step of a method.

The scope of protection of the present disclosure is given by the claims and is not limited by the features explained in the description or shown to the figures.

It is understood that the foregoing description is that of the exemplary embodiments of the disclosure and that various changes and modifications may be made thereto without departing from the spirit and scope of the disclosure as defined in the appended claims.

### LIST OF REFERENCE NUMERALS

100 Vehicle
101 Side contour
103 Height profile
105 Loading area
107 Side wall
109 Measuring system
111 Control unit
113 Brush
115 Deviation
200 Vehicle washing system

What is claimed is:

1. A method for automatically detecting a lower-lying loading area of a vehicle with an at least partially lateral side wall, the method comprising:
determining a side contour of a vehicle;
determining a height profile of the vehicle;
calculating a deviation between the side contour and the height profile; and
determining the loading area on the basis of the deviation and the position and/or extent of the loading area from a course of the deviation.

2. The method according to claim 1, wherein the depth of the loading area is determined relative to the side wall of the vehicle.

3. The method according to claim 1, wherein the side contour is determined by an electronic camera recording a side view of the vehicle.

4. The method according to claim 1, wherein the side contour is determined by a light grid moving along the vehicle.

5. The method according to claim 1, wherein the side contour is determined by an ultrasonic sensor or a radar sensor.

6. The method according to claim 1, wherein the height profile is determined in the center of the vehicle.

7. The method according to claim 1, wherein the height profile is determined by a runtime measurement of light.

8. The method according to claim 1, wherein the height profile is determined by triangulation of light.

9. The method according to claim 1, wherein the height profile is determined by an ultrasonic sensor or a radar sensor.

10. The method according to claim 1, wherein a first height profile is determined by a radar sensor and a second height profile is determined by a light sensor.

11. The method according to claim 1, wherein the method is used in a vehicle washing system.

12. A vehicle washing system suitable for carrying out the method according to claim 1, the vehicle washing system comprising:
a first measuring system for determining a side contour of a vehicle;
a second measuring system for determining a height profile of the vehicle; and
an electronic control unit for calculating a deviation between the side contour and the height profile and determining the loading area based on the deviation.
